(19) United States
(12) Patent Application Publication
(10) Pub. No.: US 2002/0157088 A1
(43) Pub. Date: Oct. 24, 2002

(54) System for and method of automating the execution of a data stream transformation project

(75) Inventors: Lewis J. Rompala, Spicewood, TX (US); David Wiegand, Edmonds, WA (US); Neil Hickey, Golden, CO (US)

Correspondence Address: Sam Pasternack, Choate, Hall & Stewart, 53 State Street, Exchange Place, Boston, MA, 02109, US

(73) Assignee: Orchid Systems, Inc., Wellesley, MA (US)

(21) Appl. No.: 09/839,467

(22) Filed: Apr. 20, 2001

(51) Int. Cl. G06F 9/45

(52) U.S. Cl. 717/137

(57) ABSTRACT

A system for and method of automating the execution of a data stream transformation project. The various embodiments described employ a trainable user interface translator application to record and manipulate data streams between a prospect's terminal emulation software and one or more prospect applications to be transformed. A remote user in communication with the prospect may observe prospect terminal screen displays, and optionally insert data, such as synchronization data into the recorded data streams. The user inserts the recorded data streams information into a targeted procedures model, which may be reviewed for approval by the prospect.

### FIELD OF THE INVENTION

The present invention relates generally to automating the execution of a data transformation project. More specifically, the invention achieves this objective by monitoring, manipulating and recording data streams into and out of the applications from which data is to be transformed via trainable user interface translator software, and using the recorded information in the creation of a targeted procedures model.

### BACKGROUND OF THE INVENTION

A data stream transformation is a method of converting the operation and organization of an existing host application to another organization and operation. Data stream transformation allows better functionality and provides new operations to the existing system. Examples include enabling web and wireless access to and adding additional data transfer interfaces to existing applications.

Unfortunately, current methods for designing and deploying a data stream transformation are not performed with the highest efficiency possible. Certain operations that are required to define the data stream transformation are repeated, from scratch, during the implementation phase. For example, the current methods employed to capture screen displays and understand host application interaction are largely manual, resulting in data stream transformations that are potentially labor-intensive, costly, and error-prone. In addition, current data stream transformation processes require a highly trained user to conduct the transformation, leading to higher costs for the data stream transformation provider. What is needed is a way to automate the execution of a data stream transformation project, leading to more rapidly executed projects, lower costs, and increased customer satisfaction with the data stream transformation provider.

The definition and implementation steps of a data stream transformation project are currently performed independently, resulting in increased inefficiency during the data stream transformation process. This inefficiency results in a slower data transformation delivery cycle and reduced customer satisfaction with the data stream transformation provider. What is needed is a way to dramatically reduce the time required to create the definition of a data stream transformation project and dramatically reduce the time required to then implement it.

The fact that the design phase, the creation of a TPM, and the implementation of the transformation are currently executed independently results in potential inconsistencies occurring during the data stream transformation project. These inconsistencies may lead to a lower quality product and reduced customer satisfaction with the data stream transformation provider. What is needed is a way to increase consistency between the design phase of the data stream transformation project, the contents of the actual specification document, and the results of the data stream transformation itself.

The current data stream transformation design and implementation processes require highly trained personnel to properly perform the necessary steps. Unfortunately, technically skilled personnel can sometimes be difficult to locate and training can be a drain on company resources, leading to reduced revenue and slower project delivery times. What is needed is a way to lower the level of technical competency required to deliver a data stream transformation project, and enable an untrained prospect to perform more of the work required to prepare the specification of the data stream transformation.

### SUMMARY OF THE INVENTION

The present invention is a system for and method of automating the execution of a data stream transformation project, the specifications of which are stored in a Transformation Project Model (“TPM”). For a description of a TPM, see a co-pending patent application assigned to the assignee of the present invention entitled “Method of and Apparatus for Remotely Preparing a Targeted Procedures Model for Transforming a Data Stream”, filed Feb. 7, 2001, respectively, and incorporated by reference into the current application. The embodiments described below share the ability to monitor, record, and manipulate data streams by means of a “monitoring software” application. The techniques employed in the in the present invention build upon “trainable user interface translator” technology as described in U.S. Pat. Nos. 5,627,977 and 5,889,516, which are assigned to the assignee of the present application and which are hereby incorporated by reference in their entirety into the present application.

In one aspect, the present invention is a system for automating the execution of a data stream transformation project, comprising an Internet host for storing the TPM, a user site having a phone and a user computer equipped with an e-mail client, Web browser and a modem, and a prospect site having a prospect phone and a prospect computer operating one or more prospect applications and monitoring software, and equipped with a prospect terminal, a data storage device, a prospect e-mail client, prospect Web browser and prospect modem. In operation, the monitoring software records data streams flowing between prospect terminal emulation software being operated by a prospect and the one or more prospect applications, and stores the recorded data streams on the data storage device for retrieval and incorporation into the TPM by a user.

In another embodiment, the monitoring software communicates the recorded data streams to the user computer for displaying captured prospect terminal screens. The user may simply observe, or may insert data, such as synchronization points, into the data streams prior to their recording. The prospect may view and change or approve the TPM stored on the Internet host via the prospect Web browser.

In another aspect, the present invention is a method of using the apparatus described above to automate the execution of a data stream transformation project, comprising the steps recording data streams flowing between prospect terminal emulation software and the prospect applications, and then exercising the prospect applications with both normal data and data expected cause error or exceptions in the prospect applications. The prospect may employ emulation software in exercising the prospect applications. The recorded data streams are then stored on the data storage device via the monitoring software, in order that the user may retrieve them and incorporate them into the TPM.

In another embodiment, the monitoring software communicates the data streams to the user computer for display of captured prospect terminal screens. The monitoring software may accept data, such as synchronization data, from the user and insert it into the data streams before storing the data streams. The prospect may additionally view the TPM on the Internet host by means of the prospect Web browser.

Capturing the existing prospect displays allows the user to rapidly design and deploy the data stream transformation project. Development of a TPM serves to maintain consistency between the design phase of the data stream transformation project, the contents of the actual specification document, and the results of the data stream transformation itself. It accomplishes these goals while reducing the level of technical competency required to deliver a data stream transformation project. That is, an untrained prospect may perform more of the work required to prepare the specification of the data stream transformation. The prospect applications' data streams may be modeled without the risk of corrupting the prospect applications.

### BRIEF DESCRIPTION OF THE DRAWINGS

FIG. 1 is a schematic diagram of apparatus for automating the execution of a data stream transformation project.

FIG. 2 is a flow diagram illustrating a method of using the apparatus to automate the execution of a data stream transformation project.

### DETAILED DESCRIPTION

Preferred embodiments of the invention will now be described with reference to the accompanying drawings.

The present invention is a system for and method of automating the execution of a data stream transformation project. The invention utilizes trainable user interface translator monitoring and recording software during the design phase of the data stream transformation project. This software records the interaction between the skilled user and the application to be transformed in order to: a) document this use; b) present and summarize this use in the design approval document; and c) create the actual host interaction portion of a transformation rule set. Unlike the current methods, the skilled data transformation company employee (“integrator”) operates as an “observer” of the operation rather than acting as the “operator” under the tutelage of the skilled user. In addition, the recording of the operation, its review by the integrator, and the creation of the rule set need not be performed all at once. Instead, the recording may be reviewed and converted at a later date.

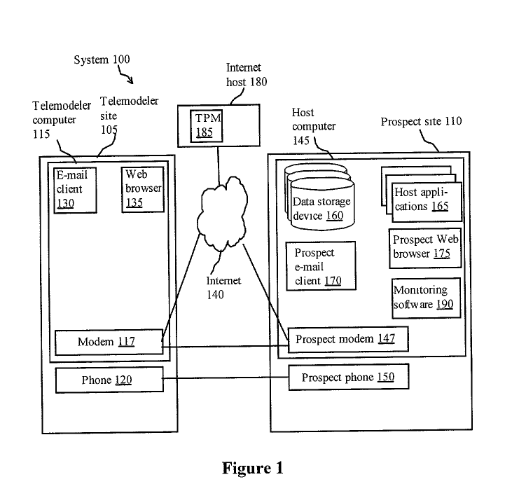

FIG. 1 shows a system 100 for automating the execution of a data stream transformation project, which includes a TeleModeler site 105, a prospect site 110, and an Internet host 180. A “TeleModeler” is a person who acquires the necessary information for and prepares a TPM 185, which is stored at Internet host 180. TeleModeler site 105 includes a TeleModeler computer 115, and a phone 120. TeleModeler computer 115 further includes a modem 117, an e-mail client 130 and a Web browser 135. TeleModeler computer 115 connects to prospect site 110 either using e-mail client 130 or Web browser 135 via the Internet 140, or using modem 117 to dial directly into prospect site 110.

Again referring to FIG. 1, prospect site 110 includes host computer 145 and a prospect phone 150. Host computer 145 further includes a prospect modem 147, data storage device 160, host applications 165, prospect e-mail client 170, a prospect Web browser 175, and monitoring software 190. The monitoring software 190 will communicate with TeleModeler computer 115 via Internet 140 or by modem connection between modems 120 and 150. Alternately, monitoring software 190 will store recorded data stream data on data storage device 160. The data file will then be transferred to TeleModeler computer 115 by any means available.

In operation, the TeleModeler can communicate with a prospect in several ways. The TeleModeler can use e-mail client 130 to send messages to prospect e-mail client 170 via Internet 140. The TeleModeler also has the option of communicating or sending messages using phone 120. The prospect receives messages via prospect phone 150. The TeleModeler may also use modem 117 to connect directly to host computer 145 via prospect modem 147, which enables the TeleModeler to access components of host computer 145, including data storage device 160 and host applications 165.

Prior to the prospect's operation of host applications 165, the monitoring software 190 will be activated. The monitoring software 190 will then record data streams between the host applications 165 and host terminal emulation software being used by the prospect. Optionally, this data will also be passed (e.g. via the Internet 140) to the TeleModeler computer 115 where images of the terminal will be displayed for the TeleModeler's review. As a further option, the Telemodeler can insert “hints” into the recorded data including host synchronization points.

Once the recording is complete, the TeleModeler incorporates the data stream data into a TPM 185, which is posted on a Web site hosted by an Internet host 180. A prospect can view TPM 185 using the prospect Web browser 175 in order to review and approve the proposed data stream transformation.

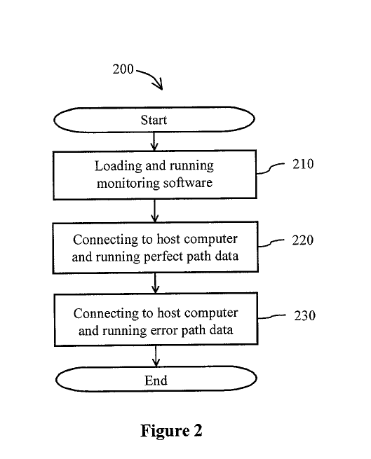

FIG. 2 is a flowchart showing a process 200 for automating the execution of a data stream transformation project, including the steps of:

Step 210: Loading and Running Monitoring Software

In this step, the prospect loads and runs monitoring software 190 on prospect site 110.

Step 220: Connecting to Host Computer and Running Perfect Path Data

In this step, the prospect runs host applications 165 using “perfect path” data. This includes (1) loading emulation software used to access host applications 165, (2) logging onto host computer 145, and (3) running host applications 165 with perfect path data. “Perfect path” data is data that will cause no errors or exceptions in the execution of host applications 165. For example, in an inventory application, the prospect enters a correct part number that causes the retrieval of a part that is known to be in stock. The prospect performs this for every business transaction that is to be transformed.

Optionally, the TeleModeler marks the host synchronization points within the data stream output from host applications 165 and the data stream input to host applications 165. This maintains the sequential nature of the data streaming into and out of host applications 165. For example, after making a request to host applications 165, it may be necessary to wait a certain number of milliseconds for the response (a first synchronization point), after which another request can be made Failure to maintain host synchronization points within the data streams to and from host applications 165 could result in disoperation of the data stream transformation.

Step 230: Connecting to Host Computer and Running Error Path Data

In this step, the prospect runs host applications 165 using error and exception data. This step includes (1) loading the emulation software used to access host applications 165, (2) logging onto host computer 145, and (3) running host applications 165. Exception data is data that causes errors or exceptions in the execution of host applications 165 with error path data. As an example of using error data in an inventory application, the prospect enters a part number that contains an insufficient number of characters. As an example of using exception data, the prospect enters a part number of a part that is known to be out of stock. The prospect will perform this step for every error or exception expected to be encountered during normal business transactions.

Optionally, the TeleModeler marks the host synchronization points within the data stream output from host applications 165 and the data stream input to host applications 165. This maintains the sequential nature of the data streaming into and out of host applications 165, as described in step 220.

Process 200 terminates after step 230.

Process 200 automatically produces data for the TPM, thereby automating the execution of a data stream transformation project.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A system for automating the execution of a data stream transformation project, comprising:
an Internet host for storing a targeted procedures model;
a user site having a phone and a user computer equipped with an e-mail client, Web browser and a modem;
a prospect site having a prospect phone and a prospect computer operating one or more prospect applications and monitoring software, and equipped with a prospect terminal, a data storage device, a prospect e-mail client, prospect Web browser and prospect modem for communicating with the user site and Internet host;
wherein the monitoring software records data streams flowing between prospect terminal emulation software being operated by a prospect at the prospect site and the one or more prospect applications, and stores the recorded data streams on the data storage device for retrieval and incorporation into the targeted procedures model.

2. The system of claim 1, wherein the monitoring software further communicates the recorded data streams to the user computer for displaying captured prospect terminal screens.

3. The system of claim 2, wherein the monitoring software accepts and inserts data from a user at the user site inserted data into the recorded data streams.

4. The system of claim 3, wherein the accepted and inserted data comprises synchronization points.

5. The system of claim 1, wherein the prospect may view the targeted procedures model using the prospect Web browser.

6. In a system comprising an Internet host for storing a targeted procedures model, a user site having a phone and a user computer equipped with an e-mail client, Web browser and a modem, and a prospect site having a prospect phone and a prospect computer operating one or more prospect applications and monitoring software, and equipped with a prospect terminal, a data storage device, a prospect e-mail client, prospect Web browser and prospect modem for communicating with the user site and Internet host, a method of using the system to automate the execution of a data stream transformation project, comprising the steps of:
initiating by a prospect at the prospect terminal the monitoring software to record data streams flowing between prospect terminal emulation software and the one or more prospect applications;
exercising by the prospect the one or more prospect applications with perfect path data;
exercising by the prospect the one or more prospect applications with error or exception data;
recording and storing on the data storage device the data streams via the monitoring software; and
retrieving the stored data streams from data storage device and incorporating the retrieved data streams into the targeted procedures model by a user.

7. The method of claim 6, further comprising the step of:
communicating via the monitoring software the data streams to the user computer for display of captured prospect terminal screens.

8. The method of claim 7, further comprising the step of:
accepting and inserting via the monitoring software data from the user into the data streams.

9. The method of claim 8, wherein the accepted and inserted data comprises synchronization points.

10. The method of claim 6, further comprising the step of:
viewing the targeted procedures model by the prospect via the prospect Web browser.

11. The method of claim 6, wherein the prospect uses emulation software in exercising the one or more prospect applications.
